(19) United States
(12) Patent Application Publication
(10) Pub. No.: US 2026/0264644 A1
(43) Pub. Date: Sep. 10, 2026

(54) WIPER, CLEANING SYSTEM, SENSOR, AND VEHICLE

(71) Applicant: AUTOX TECH PTE. LTD., SINGAPORE (SG)

(72) Inventors: Zhuo Li, Shenzhen (CN); Xingwei Peng, Shenzhen (CN); Cheng Liu, Shenzhen (CN); Hailin Xiong, Shenzhen (CN); Yizhou Shan, Shenzhen (CN); Pulin Liao, Shenzhen (CN)

(73) Assignee: AUTOX TECH PTE. LTD., SINGAPORE (SG)

(21) Appl. No.: 19/256,724

(22) Filed: Jul. 1, 2025

(30) Foreign Application Priority Data
Mar. 7, 2025 (CN) 2025102761096

(51) Int. Cl. B60S 1/56; B60S 1/44

(52) U.S. Cl. CPC B60S 1/56; B60S 1/44

(57) ABSTRACT

The disclosure provides a wiper for a sensor, the wiper is configured to clean the surface to be clean, and includes a counterweight slider; a sliding assembly, with a wiper arm configured to slide with the sliding assembly to clean the surface to be clean, and a transmission mechanism, wherein the counterweight slider and the sliding assembly are slidably coupled to the transmission mechanism, and are driven to slide at the same speed but in opposite directions by the transmission mechanism; and the counterweight slider and the sliding assembly have equal COM, ensuring a combined COM of the counterweight slider and the sliding assembly remain at a position when the wiper arm in both motion and stopped states.

### CROSS REFERENCE TO RELATED APPLICATION

This non-provisional patent application claims priority under 35 U.S. C. §119 from Chinese Patent Application No. 202510276109.6 filed on Mar. 7, 2025, the entire content of which is incorporated herein by reference.

### TECHNICAL FIELD

The present invention relates to the technical field of wipers, and particularly relates to a wiper, a cleaning system, a sensor, and a vehicle.

### BACKGROUND

An autonomous vehicle can utilize a sensor to acquire environmental information of the vehicle for navigation path planning. A sensor is a device that detects a target by transmitting and receiving signals. The sensor includes a sensor housing and a sensor component (such as a camera, a LiDAR device, a radar device, and other sensor devices) disposed inside the sensor housing. The sensor component is used to transmit and receive signals, and the signals transmitted and to be received by the sensor component need to be transmitted through the sensor housing. However, when foreign matter (e.g., rain, hail, snow, road spray, dirt, foreign substances, etc.) accumulates on a surface of the sensor housing, it will cause undesirable effects (e.g., attenuation, reflection, refraction, beam deflection, broadening, etc.) on signal transmission characteristics, which may reduce the accuracy of sensor test results.

Nowadays, there are three typical cleaning solutions for removing foreign matter on the surface of the sensor housing. The first solution is to use a high-pressure air curtain to isolate foreign matter and prevent foreign matter from polluting the surface of the sensor housing. The second solution is to spray a cleaning liquid or jet air to clean the surface of the sensor housing. The third solution is to use a wiper to wipe and clean the surface of the sensor housing. However, these cleaning solutions are generally used to clean fixed sensors and are not suitable for cleaning rotating sensors. Although there is a cleaning solution for rotating sensors in the prior art that adopts a wiper, this solution adopts a traditional rotating wiper solution. The rotating wiper is suitable for cleaning a fan-shaped wiping surface but not suitable for cleaning a rectangular wiping surface. If a rotating wiper is adopted, a longer wiper arm is required to wipe the same rectangular area, and the occupied space will also increase. In addition, the wiping motion of the wiper will cause a dynamic imbalance problem of the rotating sensor, which in turn reduces the stability and detection accuracy of the rotating sensor.

### SUMMARY

In view of the above, the disclosure provides a wiper, a cleaning system, a sensor, and a vehicle to reduce the impact of the wiping motion of the wiper on the dynamic balance of the rotating sensor.

In a first aspect, the disclosure provides a wiper for a sensor, the wiper is configured to clean the surface to be clean, and includes a counterweight slider; a sliding assembly, with a wiper arm configured to slide with the sliding assembly to clean the surface to be clean, and a transmission mechanism, wherein the counterweight slider and the sliding assembly are slidably coupled to the transmission mechanism, and are driven to slide at the same speed but in opposite directions by the transmission mechanism; and the counterweight slider and the sliding assembly have equal COM, ensuring a combined COM of the counterweight slider and the sliding assembly remain at a position when the wiper arm in both motion and stopped states.

In a second aspect, the disclosure provides a cleaning system. The cleaning system includes a wiper, a detection system, a washing system, and a controller. The wiper maintains proper contact with the surface to be clean. The detection system is configured to detect the surface to be clean in real time to obtain detection information of the surface to be clean. The washing system is provided with a cleaning liquid for assisting cleaning. The controller is communicatively connected to the wiper, the detection system, and the washing system. The controller obtains the detection information from the detection system and determines whether foreign matter exists in the surface to be clean based on the detection information. When foreign matter exists in the surface to be clean, the controller controls the washing system to spray the cleaning liquid onto the surface to be clean and controls the wiper to perform a wiping motion in the surface to be clean, thereby cleaning the surface to be clean.

In a third aspect, the disclosure provides a sensor. The sensor rotates around a rotating axis. The sensor includes a sensor body and a cleaning system disposed on the sensor body. The sensor body is provided with a rectangular surface to be clean. The cleaning system is configured to clean the surface to be clean.

In a fourth aspect, the disclosure provides a vehicle. The vehicle includes a vehicle body and a sensor disposed on the vehicle body.

In the above wiper, cleaning system, sensor, and vehicle, by providing the counterweight slider, the combine COM of the sliding assembly and the counterweight slider remains unchanged, thereby reducing the impact of the wiper's operation on the dynamic balance of the rotating sensor. In addition, by increasing the elastic force exerted by the elastic member on the rotating arm, the wiper reduces the influence of centrifugal force and Coriolis force on the downward pressure of the wiper blade, thereby reducing the impact of the rotating motion of the rotating sensor on the wiping performance of the wiper.

### BRIEF DESCRIPTION OF THE DRAWINGS

To more clearly illustrate the technical solutions in the embodiments of the disclosure or in the prior art, the following will briefly introduce the drawings to be used in the description of the embodiments or the prior art. It is apparent that the drawings described below are merely some embodiments of the disclosure, and for those skilled in the art, other drawings can be obtained based on the structures shown in these drawings without creative efforts.

FIG. 1 is a schematic diagram of an external structure of a sensor in accordance with an embodiment.

FIG. 2 is a schematic diagram of an internal structure of a sensor in accordance with an embodiment.

FIG. 3 is a first cross-sectional view of a wiper in accordance with an embodiment.

FIG. 4 is a rear view of a wiper in accordance with an embodiment.

FIG. 5 is a front view of a wiper in accordance with an embodiment.

FIG. 6 is a side view of a wiper in accordance with an embodiment.

FIG. 7 is a second cross-sectional view of a wiper in accordance with an embodiment.

FIG. 8 is a force diagram of a wiper in accordance with an embodiment.

FIG. 9 is a schematic diagram of counterweighting by a counterweight slider in accordance with an embodiment.

FIG. 10 is a schematic diagram of counterweighting by a counterweight block in accordance with an embodiment.

FIG. 11 is a schematic diagram of electrical connections of a sensor in accordance with an embodiment.

FIG. 12 is a schematic diagram of a structure of a vehicle in accordance with an embodiment.

### REFERENCE NUMBER IN THE DRAWINGS

Wiper—1, Counterweight Slider—12, Washing System—3, Sliding Assembly—11, Transmission mechanism—13, Controller—4, Driving Slider—111, Drive Module—131, Counterweight Planes—S1, S2, Wiper Arm Assembly—112, Rotating Shaft—132, Rotating Axis—X1, Driving Arm—1121, Flexible Steel Belt—133, Vehicle Body—200, Rotating Assembly—1122, Driving Slider Guide Rail—134, Vehicle—1000, Rotating Arm—11221, Counterweight Slider Guide Rail—135, Downward Pressure—F, First Rotating Segment—C1, Control Module—136, Elastic Force—Fs, Second Rotating Segment—C2, Sensor—100, Centrifugal+Coriolis Force—Fn, First Rotating Shaft—11222, Sensor Body—101, COM of Sliding Assembly—11a, Wiper Blade Holder—11224, surface to be clean—1011, COM of Counterweight Slider—12a, Wiper Blade—11225, Counterweight Block—1012, combine COM of Sliding Assembly and Counterweight Slider—1a, Second Rotating Shaft—11226, Cleaning System—102, COM of Counterweight Block—1012a, Elastic Member—1123, Detection System—2.

The realization of the object, functional features, and advantages of the disclosure will be further described below with reference to the embodiments and the drawings.

### DETAILED DESCRIPTION OF THE EMBODIMENTS

In order to make the purpose, technical solution, and advantages of disclosure clearer and clearer, the following will provide further detailed explanations of disclosure in conjunction with the accompanying drawings and embodiments. It should be understood that the specific embodiments described here are only intended to explain the disclosure and are not intended to limit the disclosure. Based on the embodiments in disclosure, all other embodiments obtained by ordinary technical personnel in this field without creative labor fall within the scope of protection of disclosure.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is understood that the descriptions involving “first,” “second,” etc., in the disclosure are solely for descriptive purpose and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

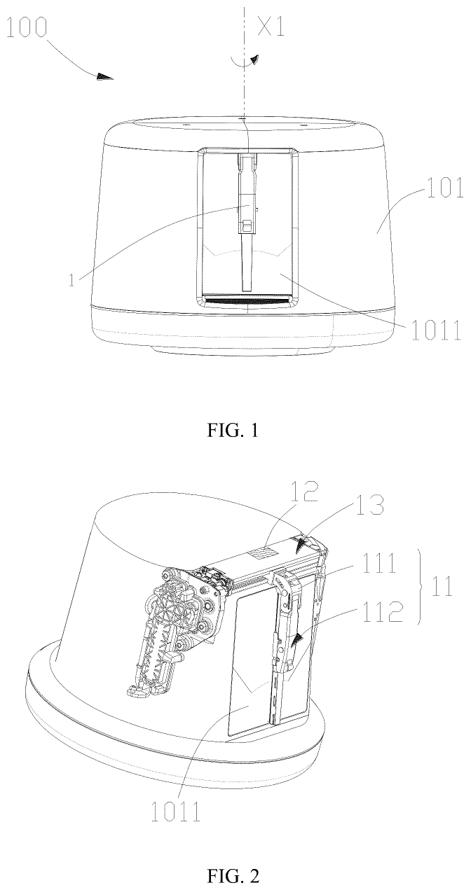

Referring to FIG. 1, which illustrates an external structure of a sensor in accordance with an embodiment. The disclosure provides a wiper 1. The wiper 1 is installed on a rotating sensor 100. The sensor 100 rotates around a rotating axis X1. A side surface of the sensor 100 is provided with a surface to be clean 1011. The wiper 1 contacts the surface to be clean 1011. The wiper 1 cleans foreign matter accumulated in the surface to be clean 1011 when the sensor 100 is stationary or rotating. The foreign matter includes but is not limited to rain, hail, snow, road spray, and dirt.

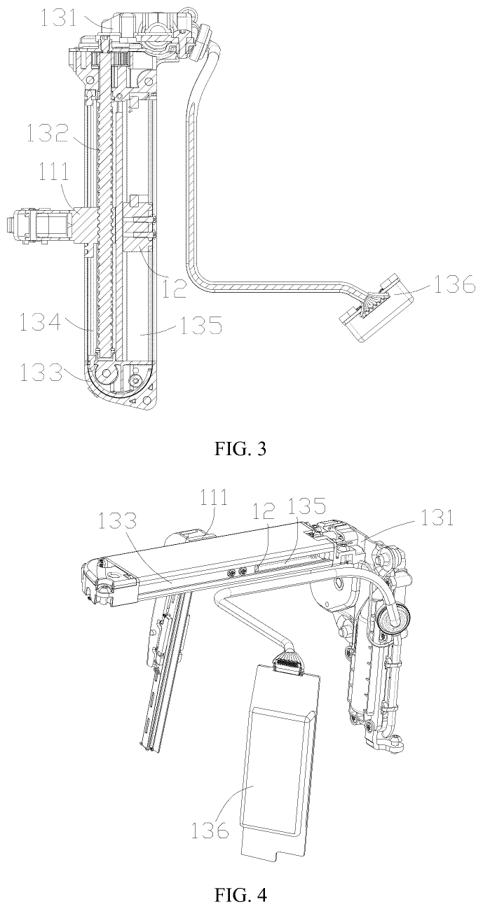

Referring to FIG. 2 in combination, which illustrates an internal structure of a sensor in accordance with an embodiment. The wiper 1 provided in the disclosure includes a transmission mechanism 13, a counterweight slider 12, and a sliding assembly 11. The transmission mechanism 13 is located on a top surface of the sensor 100 and forms a certain angle with the side surface where the surface to be clean 1011 is located. The sliding assembly 11 and the counterweight slider 12 are respectively coupled to the transmission mechanism 13 (the counterweight slider 12 in FIG. 2 is only schematic, and the specific structure of the counterweight slider 12 is shown in FIG. 3). The sliding assembly 11 includes a driving slider 111 and a wiper arm assembly 112 extending from the driving slider 111 toward the surface to be clean 1011. A side of the wiper arm assembly 112 close to the driving slider 111 slidingly contacts the surface to be clean 1011. The sliding assembly 11 is coupled to the transmission mechanism 13 via the driving slider 111. The driving slider 111 slides with the transmission of the transmission mechanism 13, thereby driving the wiper arm assembly 112 to reciprocate over the surface to be clean 1011, thereby cleaning the surface to be clean 1011. In this embodiment, the wiper arm assembly 112 is substantially 7-shaped.

Referring to FIG. 3 in combination, which illustrates a first cross-sectional structure of a wiper in accordance with an embodiment. The transmission mechanism 13 includes a drive module 131, a rotating shaft 132, a flexible steel belt 133, a driving slider guide rail 134, a counterweight slider guide rail 135, and a control module 136. The flexible steel belt 133 is substantially U-shaped. The driving slider 111 and the counterweight slider 12 are respectively coupled to two ends of the flexible steel belt 133. In addition, the transmission mechanism 13 is designed with a U-shaped path adapted to the shape of the flexible steel belt 133 for the flexible steel belt 133 to slide along the U-shaped path. The U-shaped path includes an arc path and two linear paths located at two ends of the arc path. The driving slider guide rail 134 and the counterweight slider guide rail 135 are respectively located inside the two linear paths and are parallel to the two linear paths, so that the driving slider 111 and the counterweight slider 12 slide relative to each other along the driving slider guide rail 134 and the counterweight slider guide rail 135, respectively.

Referring to FIG. 4, which illustrates a rear structure of a wiper in accordance with an embodiment. The drive module 131 is located on a side of the U-shaped path away from the arc path. The rotating shaft 132 extends from the drive module 131 toward the driving slider 111 to be rotatably connected to the driving slider 111. The control module 136 is electrically connected to the drive module 131. The control module 136 controls the drive module 131 to drive the rotating shaft 132 to rotate, so that the driving slider 111 moves linearly along an axial direction of the rotating shaft 132, thereby driving the flexible steel belt 133 to slide along the U-shaped path, and further driving the counterweight slider 12 to slide at the same speed but in an opposite direction as the driving slider 111. In this embodiment, the rotating shaft 132 is provided with an external thread, and the driving slider 111 is provided with an internal thread. The rotating shaft 132 and the driving slider 111 are engaged via the external thread and the internal thread, so that the rotating shaft 132 rotates to drive the driving slider 111 to move linearly along the axial direction of the rotating shaft 132. It can be understood that the drive module 131 controls the rotating direction (forward or reverse) of the rotating shaft 132 to control the driving slider 111 to slide toward or away from the drive module 131. When the driving slider 111 slides toward the drive module 131, the counterweight slider 12 slides away from the drive module 131. When the driving slider 111 slides away from the drive module 131, the counterweight slider 12 slides toward the drive module 131.

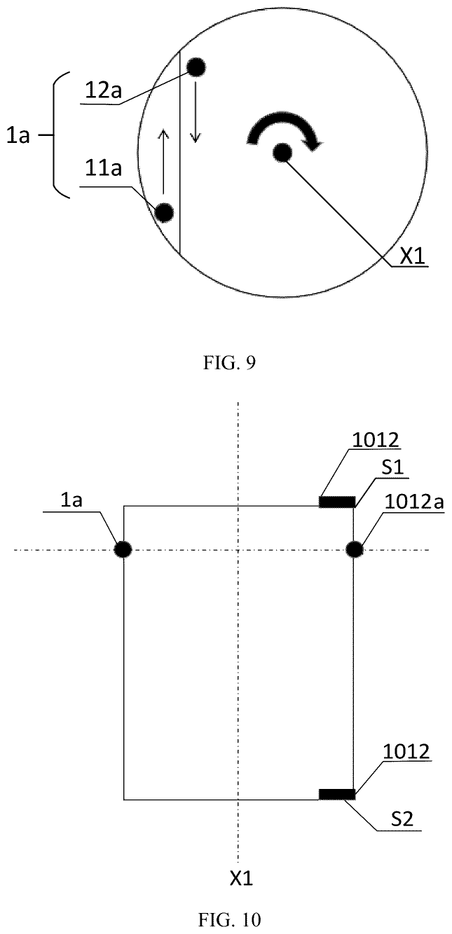

Referring to FIG. 9 in combination, which illustrates counterweighting by a counterweight slider in accordance with an embodiment. A center of mass (COM) of the counterweight slider 12 is configured to be equal to a COM of the sliding assembly 11. Meanwhile, the counterweight slider 12 and the driving slider 111 slide relative to each other at the same speed but in opposite directions. The sliding assembly 11 is coupled to the transmission mechanism 13 via the driving slider 111. That is, the counterweight slider 12 and the sliding assembly 11 also slide relative to each other at the same speed but in opposite directions (as shown in FIG. 9, the COM 12a of the counterweight slider and the COM 11a of the sliding assembly move relative to each other at the same speed but in opposite directions). In this embodiment, the COM position of the rotating sensor 100 is adjusted by adding the counterweight slider 12, so that the COM position of the rotating sensor 100 remains on the rotating axis X1 whether the wiper 1 is operating or not, thereby reducing the impact of the wiping motion of the wiper 1 on the dynamic balance of the rotating sensor 100. On the one hand, by configuring the COM of the counterweight slider 12 to be equal to the COM of the sliding assembly 11, when the sensor 100 rotates and the wiper 1 does not operate, the combine COM 1a of the sliding assembly 11 and the counterweight slider 12 will remain unchanged. At this time, dynamic balance balancing is performed on the rotating sensor 100 so that the combine COM of the sensor 100 is located on the rotating axis X1. However, when the sensor 100 rotates and the wiper 1 operates, the sliding of the sliding assembly 11 will change the combine COM 1a of the sliding assembly 11 and the counterweight slider 12 (i.e., the combine COM of the sensor 100 deviates from the rotating axis X1). At this time, the wiper 1 will have an impact on the dynamic balance of the rotating sensor 100. Therefore, it is further necessary to configure the counterweight slider 12 to slide at the same speed but in an opposite direction as the sliding assembly 11, so that the combine COM 1a of the sliding assembly 11 and the counterweight slider 12 remains unchanged, thereby reducing the impact of the wiper 1 on the dynamic balance of the rotating sensor 100 when the wiper 1 operates.

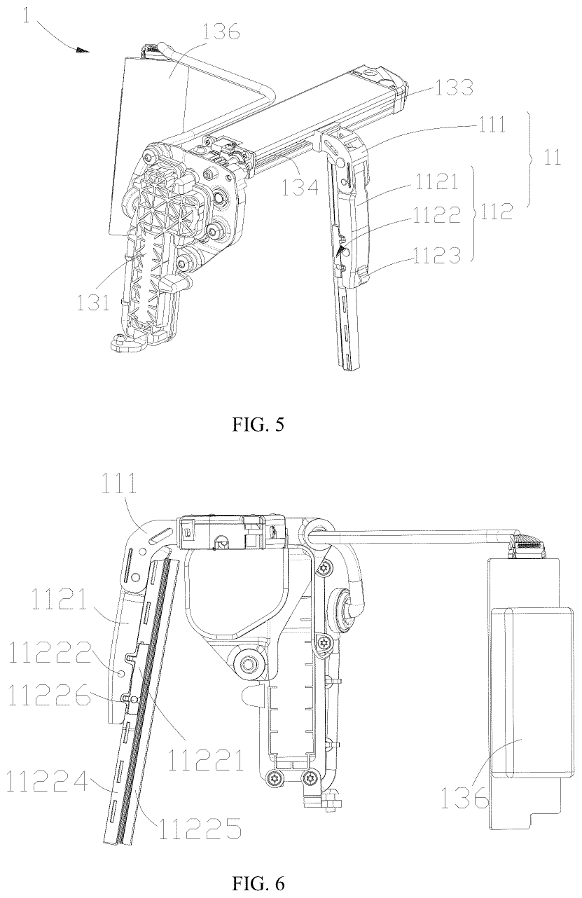

Referring to FIG. 5, which illustrates a front structure of a wiper in accordance with an embodiment. The wiper arm assembly 112 is sequentially provided with a driving arm 1121, an elastic member 1123, and a rotating assembly 1122. The driving arm 1121 is rotatably connected to both the driving slider 111 and the rotating assembly 1122. The elastic member 1123 is disposed between the driving arm 1121 and the rotating assembly 1122 (although the elastic member 1123 is exposed outside the driving arm 1121 in FIG. 5, this is only for convenience of understanding the position and structure of the elastic member 1123. In fact, the elastic member 1123 of the disclosure is not exposed outside the driving arm 1121). In this embodiment, the driving arm 1121 can be flipped up during maintenance to facilitate replacement of the wiper blade. In this embodiment, the elastic member 1123 is a compression spring. In some other feasible embodiments, the elastic member 1123 may further be a spring, foam, a washer, a spring leaf, a rubber band, or other objects having elastic stretching action.

Referring to FIG. 2 and FIG. 6, which illustrate a side structure of a wiper in accordance with an embodiment. The rotating assembly 1122 includes a rotating arm 11221, a first rotating shaft 11222, a second rotating shaft 11226, a wiper blade holder 11224, and a wiper blade 11225. The rotating arm 11221, the wiper blade holder 11224, and the wiper blade 11225 are sequentially disposed along the direction in which the driving arm 1121 is close to the surface to be clean 1011. In this embodiment, two edges of the driving arm 1121, the rotating arm 11221, and the wiper blade holder 11224 all extend toward the surface to be clean 1011, so that the driving arm 1121, the rotating arm 11221, and the wiper blade holder 11224 are all groove-shaped with grooves facing the surface to be clean 1011. The widths of the driving arm 1121, the rotating arm 11221, the wiper blade holder 11224, and the wiper blade 11225 are sequentially reduced, so that the driving arm 1121, the rotating arm 11221, the wiper blade holder 11224, and the wiper blade 11225 are sequentially engaged with each other. In this embodiment, the wiper blade 11225 has a fixed length. The wiper 1 reciprocates linearly, i.e., the wiping surface of the sliding wiper 1 is rectangular, which can be adapted to the wiping of a rectangular surface to be clean 1011. However, the wiping surface of the traditional rotating wiper 1 is fan-shaped, which is not suitable for the wiping of a rectangular surface to be clean 1011. It can be understood that adopting a rotating wiper 1 to wipe the same rectangular area requires a longer wiper arm and occupies more space. Therefore, the sliding wiper 1 of the disclosure realizes cleaning of a rotating sensor housing with a rectangular wiping surface. In some other feasible embodiments, the wiper blade 11225 is a telescopic wiper blade 11225, i.e., the wiper blade 11225 can change its length as the sliding wiper 1 slides, to be adapted to the wiping of an arc-shaped surface to be clean 1011.

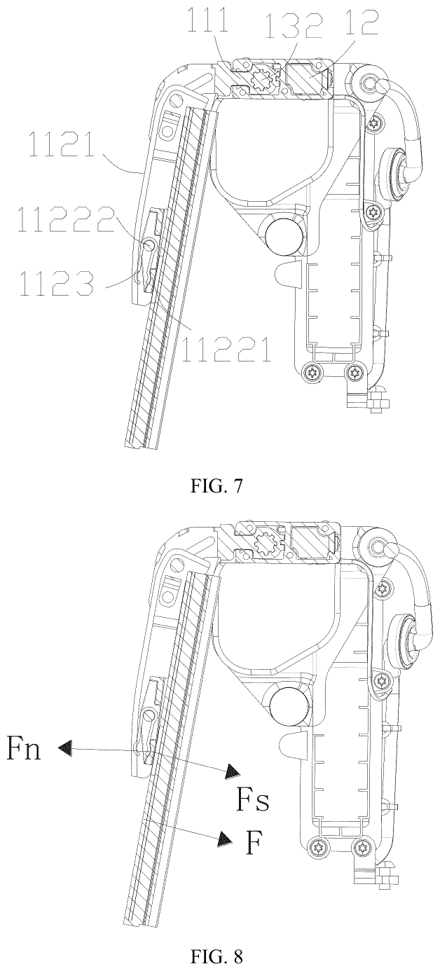

Referring to FIG. 7 in combination, which illustrates a second cross-sectional structure of a wiper in accordance with an embodiment. The first rotating shaft 11222 sequentially penetrates the driving arm 1121 and the rotating arm 11221, so that the rotating arm 11221 can rotate relative to the driving arm 1121 around the first rotating shaft 11222 within a certain range, thereby driving the wiper blade 11225 to contact and maintain proper contact with the surface to be clean 1011. The second rotating shaft 11226 sequentially penetrates the rotating arm 11221 and the wiper blade holder 11224, so that the wiper blade holder 11224 can rotate relative to the rotating arm 11221 around the second rotating shaft 11226 within a certain range, thereby driving the wiper blade 11225 to rotate so that the wiper blade 11225 uniformly contacts the surface to be clean 1011. In this embodiment, the rotating arm 11221 includes a first rotating segment C1 close to the driving slider 111 and a second rotating segment C2 away from the driving slider 111. The first rotating shaft 11222 is disposed between the first rotating segment C1 and the second rotating segment C2. The second rotating shaft 11226 is disposed at an end of the second rotating segment C2.

Referring to FIG. 8 in combination, which illustrates a force condition of a wiper in accordance with an embodiment. The elastic member 1123 is wound around the first rotating shaft 11222 and extends out two elastic ends. The two elastic ends respectively abut against the rotating arm 11221 and the driving arm 1121. The elastic member 1123 is in a compressed state. The elastic member 1123 exerts an elastic force on the rotating arm 11221. The elastic force causes the rotating arm 11221 to generate a downward pressure F and transmit the downward pressure F to the wiper blade 11225 via the wiper blade holder 11224, so that the wiper blade 11225 contacts and maintains proper contact with the surface to be clean. It can be understood that the magnitude of the elastic force exerted by the elastic member 1123 on the rotating arm 11221 depends on the compression degree of the elastic member 1123. The compression degree of the elastic member 1123 can be preset according to actual needs, which is not limited here. In this embodiment, since the wiper 1 is installed on the rotating sensor 100, the rotating motion of the sensor 100 will cause the wiper 1 to be subjected to centrifugal force. If the wiper 1 operates while the sensor 100 rotates, the wiper 1 will also be subjected to Coriolis force. The centrifugal force and Coriolis force (the sum of centrifugal force and Coriolis force is Fn as shown in FIG. 8) acting on the rotating assembly 1122 are opposite to the direction of the elastic force Fs, so centrifugal force and Coriolis force will affect the downward pressure F of the wiper blade 11225 in the wiper 1. Therefore, the disclosure increases the elastic force Fs exerted by the elastic member 1123 on the rotating arm 11221 to reduce the impact of Fn on the downward pressure F of the wiper blade 11225. It can be understood that when the elastic force Fs is sufficiently large, even if centrifugal force and Coriolis force Fn exist, after the elastic force Fs offsets centrifugal force and Coriolis force Fn, the remaining elastic force can still enable the wiper blade 11225 to have sufficient downward pressure F, thereby reducing the impact of Fn on the downward pressure F of the wiper blade 11225, and further reducing the impact of the rotating motion of the rotating sensor 1 on the wiping performance of the wiper 1.

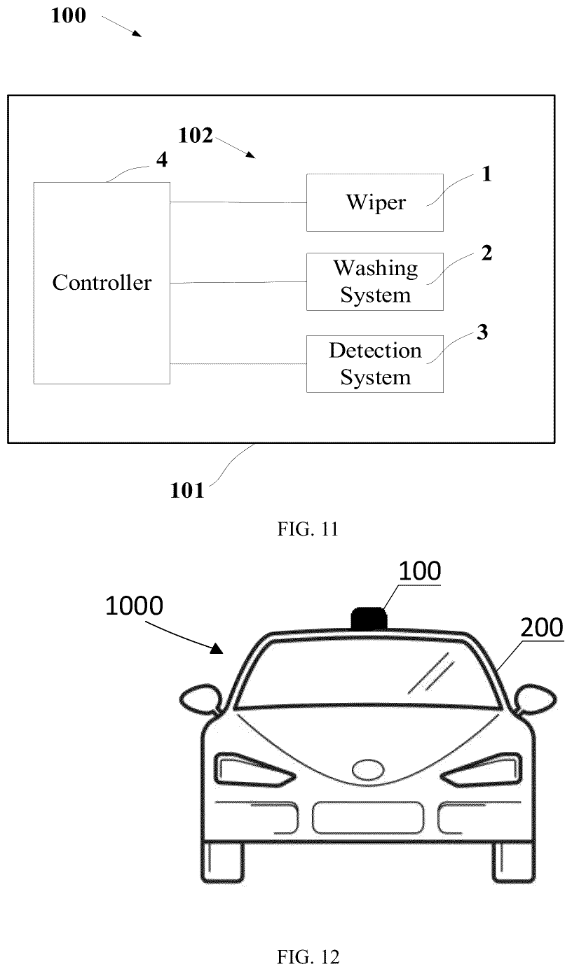

Referring to FIG. 11 in combination, which illustrates electrical connections of a sensor in accordance with an embodiment. The disclosure further provides a sensor 100. The sensor includes a sensor body 101 and a cleaning system 102 disposed on the sensor body 101. The sensor body 101 includes a sensor housing. The sensor housing is provided with a surface to be clean 1011. The surface to be clean 1011 is a region in the sensor housing that needs to allow signal transmission. The cleaning system 102 is configured to clean the surface to be clean 1011. In this embodiment, the sensor 100 includes but is not limited to a light detection and ranging (LiDAR) sensor, a radio detection and ranging (radar) sensor, a sonar navigation and ranging (sonar) sensor, an image capture device (such as a camera), a microphone sensor, and other sensors suitable for recording and scanning surrounding data.

The cleaning system 102 includes a wiper 1, a detection system 2, a washing system 3, and a controller 4. The wiper 1 maintains proper contact with the surface to be clean 1011. The detection system 2 is configured to detect the surface to be clean 1011 in real time to obtain detection information of the surface to be clean 1011. The washing system 3 is provided with a cleaning liquid for assisting cleaning. The controller 4 is communicatively connected to the wiper 1, the detection system 2, and the washing system 3. The controller 4 obtains the detection information from the detection system 2 and determines whether foreign matter exists in the surface to be clean 1011 based on the detection information. When foreign matter exists in the surface to be clean 1011, the controller 4 controls the washing system 3 to spray the cleaning liquid onto the surface to be clean 1011 and controls the wiper 1 to perform a wiping motion in the surface to be clean, thereby cleaning the surface to be clean 1011.

In some feasible embodiments, the wiper 1 can be configured to continuously or periodically remove foreign matter accumulated in the surface to be clean 1011. For example, when the controller 4 determines based on the detection information that foreign matter exists in the surface to be clean 1011, the controller 4 activates the wiper 1. When it is determined that the surface to be clean 1011 has been sufficiently cleaned, the wiper 1 can be deactivated to improve the service life of the wiper 1.

Referring to FIG. 10 in combination, which illustrates counterweighting by a counterweight block in accordance with an embodiment. The sensor 100 further includes a counterweight block 1012. The counterweight block 1012 is disposed on two counterweight planes S1 and S2 on opposite sides of the rotating axis X1 (i.e., the other side of the sensor 100 where the sliding assembly 11 and the counterweight slider 12 are located, which is symmetrical to the rotating axis X1). Meanwhile, a combine COM of the counterweight blocks 1012 on the two counterweight planes S1 and S2 is equal to combine COM of the sliding assembly 11 and the counterweight slider 12. It can be understood that when the COM distribution of structures on two sides of the rotating axis X1 is uneven (i.e., the COMs of structures of the sensor 100 on two sides of the rotating axis X1 are not symmetrical about the rotating axis X1), the sensor 100 will generate a couple when rotating, thereby causing a dynamic imbalance problem of the sensor 100. The disclosure adjusts the COM distribution of structures on two sides of the rotating axis X1 of the sensor 100 by providing the counterweight block 1012, so that the combine COM 1012a of the counterweight blocks 1012 on the two counterweight planes S1 and S2 and the combine COM 1a of the sliding assembly 11 and the counterweight slider 12 are completely symmetrical about the rotating axis X1, thereby eliminating the dynamic imbalance problem caused by the couple generated due to uneven mass distribution.

It can be understood that the dynamic imbalance problem of the sensor is caused on the one hand by the wiping motion of the wiper and on the other hand by the couple generated due to uneven mass distribution of structures on two sides of the rotating axis of the sensor. Therefore, the disclosure provides the counterweight slider to keep the combine COM of the sliding assembly and the counterweight slider unchanged, thereby reducing the impact of the wiper's operation on the dynamic balance of the rotating sensor. Meanwhile, the disclosure provides the counterweight block to make the combine COM of the counterweight block on the two counterweight planes and the combine COM of the sliding assembly and the counterweight slider completely symmetrical about the rotating axis, thereby eliminating the dynamic imbalance problem caused by the couple generated due to uneven mass distribution.

Referring to FIG. 12 in combination, which illustrates a structure of a vehicle in accordance with an embodiment. The disclosure further provides a vehicle 1000. The vehicle 1000 includes a vehicle body 200 and a sensor 100 disposed on the vehicle body 200. The structure of the sensor 100 has been described in detail above and will not be repeated here. In addition, the vehicle 1000 can be a manually driven vehicle or an autonomous vehicle, which is not limited here.

It is apparent to those skilled in the art that various modifications and variations can be made to the disclosure without departing from the spirit and scope thereof. Therefore, if these modifications and variations of the disclosure fall within the scope of the claims and their equivalent technologies, the disclosure also intends to include these modifications and variations.

The foregoing are merely preferred embodiments of the disclosure and cannot be used to limit the scope of the claims of the disclosure. Therefore, equivalent changes made in accordance with the claims of the disclosure still fall within the scope encompassed by the disclosure.

1. A wiper for a sensor with a surface to be clean, the wiper being configured to clean the surface to be clean, and comprising:
a counterweight slider;
a sliding assembly, with a wiper arm configured to slide with the sliding assembly to clean the surface to be clean, and
a transmission mechanism;
wherein the counterweight slider and the sliding assembly are slidably coupled to the transmission mechanism, and are driven to slide at the same speed but in opposite directions by the transmission mechanism; and the counterweight slider and the sliding assembly have equal COM, ensuring a combined COM of the counterweight slider and the sliding assembly remain at a position when the wiper arm in both motion and stopped states.

2. The wiper according to claim 1, wherein the sensor is a LiDAR, the surface to be clean is a surface of a window of the LiDAR.

3. The wiper according to claim 1, wherein LiDAR is capable of rotating.

4. The wiper according to claim 1, wherein the sliding assembly further comprises a driving slider, enabling the sliding assembly to be coupled to the transmission mechanism, the wiper arm assembly extends from the driving slider toward the surface to be clean.

5. The wiper according to claim 4, wherein the wiper arm comprises a driving arm, and a rotating assembly including a rotating arm and an elastic member; the driving arm is rotatably connected to both the driving slider and the rotating arm; the elastic member is disposed between the rotating arm and the driving arm to exert an elastic force on the rotating arm; and the wiper arm assembly is driven by the driving slider to reciprocate over the surface to be clean to perform cleaning on the surface to be clean.

6. The wiper according to claim 4, wherein the transmission mechanism includes a rotating shaft, and a flexible steel belt, the rotating shaft is rotatably connected to the sliding assembly, the flexible steel belt is substantially U-shaped, the sliding assembly and the counterweight slider being respectively coupled to two ends of the flexible steel belt; the sliding assembly moves linearly along an axial direction of the rotating shaft when the rotating shaft rotates, to drive the flexible steel belt to slide along a U-shaped path, thereby driving the counterweight slider to slide at the same speed but in the opposite direction as the sliding assembly.

7. The wiper according to claim 6, wherein the rotating shaft is provided with an external thread, the sliding assembly is provided with an internal thread, and the rotating shaft and the sliding assembly are engaged via the external thread and the internal thread, so that the sliding assembly moves linearly along the axial direction of the rotating shaft when the rotating shaft rotates.

8. The wiper according to claim 6, wherein the transmission mechanism further comprises a driving slider guide rail, and a counterweight slider guide rail, the driving slider guide rail and the counterweight slider guide rail are respectively located on two linear paths of the U-shaped path, so that the driving slider and the counterweight slider slide relative to each other along the driving slider guide rail and the counterweight slider guide rail, respectively.

9. The wiper according to claim 4, wherein the rotating assembly further includes a first rotating shaft, a wiper blade holder, and a wiper blade; the rotating arm and the wiper blade are respectively coupled to opposite sides of the wiper blade holder; the elastic member is wound around the first rotating shaft, the elastic member extending out two elastic ends, the two elastic ends respectively abutting against the rotating arm and the driving arm; the elastic member exerts an elastic force on the rotating arm, so that the rotating arm generates a downward pressure and the downward pressure is transmitted to the wiper blade via the wiper blade holder, thereby causing the wiper blade to contact and maintain proper contact with the surface to be clean.

10. The wiper according to claim 9, wherein the rotating assembly further includes a second rotating shaft, the wiper blade holder being rotatably connected to the rotating arm via the second rotating shaft, the wiper blade holder rotates around the second rotating shaft, thereby driving the wiper blade to rotate so that the wiper blade uniformly contacts the surface to be clean.

11. A sensor, sensor rotating around a rotating axis, and comprising:
a sensor body, with a surface to be clean; and
a wiper, to clean the surface to be clean, and comprising:
a counterweight slider;
a sliding assembly, with a wiper arm configured to slide with the sliding assembly to clean the surface to be clean, and
a transmission mechanism;
wherein the counterweight slider and the sliding assembly are slidably coupled to the transmission mechanism, and are driven to slide at the same speed but in opposite directions by the transmission mechanism; and the counterweight slider and the sliding assembly have equal COM, ensuring a combined COM of the counterweight slider and the sliding assembly remain at a position when the wiper arm in both motion and stopped states.

12. The sensor according to claim 11, wherein the sliding assembly further comprises a driving slider, enabling the sliding assembly to be coupled to the transmission mechanism, the wiper arm assembly extends from the driving slider toward the surface to be clean.

13. The sensor according to claim 12, wherein the wiper arm comprises a driving arm, and a rotating assembly including a rotating arm and an elastic member; the driving arm is rotatably connected to both the driving slider and the rotating arm; the elastic member is disposed between the rotating arm and the driving arm to exert an elastic force on the rotating arm; and the wiper arm assembly is driven by the driving slider to reciprocate over the surface to be clean to perform cleaning on the surface to be clean.

14. The sensor according to claim 13, wherein the transmission mechanism includes a rotating shaft, and a flexible steel belt, the rotating shaft is rotatably connected to the sliding assembly, the flexible steel belt is substantially U-shaped, the sliding assembly and the counterweight slider being respectively coupled to two ends of the flexible steel belt; the sliding assembly moves linearly along an axial direction of the rotating shaft when the rotating shaft rotates, to drive the flexible steel belt to slide along a U-shaped path, thereby driving the counterweight slider to slide at the same speed but in the opposite direction as the sliding assembly.

15. The sensor according to claim 14, wherein the rotating shaft is provided with an external thread, the sliding assembly is provided with an internal thread, and the rotating shaft and the sliding assembly are engaged via the external thread and the internal thread, so that the sliding assembly moves linearly along the axial direction of the rotating shaft when the rotating shaft rotates.

16. The sensor according to claim 14, wherein the transmission mechanism further comprises a driving slider guide rail, and a counterweight slider guide rail, the driving slider guide rail and the counterweight slider guide rail are respectively located on two linear paths of the U-shaped path, so that the driving slider and the counterweight slider slide relative to each other along the driving slider guide rail and the counterweight slider guide rail, respectively.

17. The sensor according to claim 12, wherein the rotating assembly further includes a first rotating shaft, a wiper blade holder, and a wiper blade; the rotating arm and the wiper blade are respectively coupled to opposite sides of the wiper blade holder; the elastic member is wound around the first rotating shaft, the elastic member extending out two elastic ends, the two elastic ends respectively abutting against the rotating arm and the driving arm; the elastic member exerts an elastic force on the rotating arm, so that the rotating arm generates a downward pressure and the downward pressure is transmitted to the wiper blade via the wiper blade holder, thereby causing the wiper blade to contact and maintain proper contact with the surface to be clean.

18. The sensor according to claim 17, wherein the rotating assembly further includes a second rotating shaft, the wiper blade holder being rotatably connected to the rotating arm via the second rotating shaft, the wiper blade holder rotates around the second rotating shaft, thereby driving the wiper blade to rotate so that the wiper blade uniformly contacts the surface to be clean.

19. The sensor according to claim 8, wherein the sensor further includes a counterweight block, the COM of the counterweight block being equal to combine COM of the sliding assembly and the counterweight slider.

20. A vehicle, wherein the vehicle includes:
a vehicle body; and
a sensor, mounted on the vehicle; the
a sensor body, with a surface to be clean; and
a wiper, to clean the surface to be clean, and comprising:
a counterweight slider;
a sliding assembly, with a wiper arm configured to slide with the sliding assembly to clean the surface to be clean, and
a transmission mechanism;
wherein the counterweight slider and the sliding assembly are slidably coupled to the transmission mechanism, and are driven to slide at the same speed but in opposite directions by the transmission mechanism; and the counterweight slider and the sliding assembly have equal COM, ensuring a combined COM of the counterweight slider and the sliding assembly remain at a position when the wiper arm in both motion and stopped states.
